(19) United States
(12) Patent Application Publication
(10) Pub. No.: US 2011/0224949 A1
(43) Pub. Date: Sep. 15, 2011

(54) STICK-SLIP DETECTING DEVICE AND DETECTING METHOD

(75) Inventors: Tetsuya Tabaru, Tokyo (JP); Minoru Fukuda, Tokyo (JP)

(73) Assignee: YAMATAKE CORPORATION, Tokyo (JP)

(21) Appl. No.: 13/044,662

(22) Filed: Mar. 10, 2011

(30) Foreign Application Priority Data
Mar. 12, 2010 (JP) 2010-055810

(51) Int. Cl. G06F 15/00

(52) U.S. Cl. 702/183

(57) ABSTRACT

For example, a regulator valve may be controlled from the outside through a positioner, or may be controlled autonomously by an adjusting mechanism in the valve. The result of the control is a change in the dislocation of the valve stem (movable portion). Additionally, there will be a change in a process change magnitude, such as the magnitude of flow of a fluid that passes through the regulator valve, in accordance with the magnitude of dislocation of the valve stem. In this way, the diagnosing operation controlling portion controls the operation of the diagnosing portion based on the magnitude of dislocation of the valve stem or on the magnitude of change of the measurement results (the measurement value) of a process change magnitude.

### CROSS REFERENCE TO RELATED APPLICATIONS

The present application claims priority under 35 U.S.C. §119 to Japanese Patent Application No. 2010-055810, filed Mar. 12, 2010, which is incorporated herein by reference.

### FIELD OF TECHNOLOGY

The present invention relates to a stick-slip detecting device and detecting method for detecting stick-slip in the operation of a device having a sliding surface having a contact friction portion, such as a regulator valve or a gas governor.

### BACKGROUND OF THE INVENTION

Failures in regulator valves or gas governors can be diagnosed by detecting the occurrence of stick-slip in a sliding part. Stick-slip occurs due to the state of a piston 1001, a cylinder 1002, and a contact sliding portion 1003, as illustrated in, for example, FIG. 10. For example, this stick-slip occurs when, for example, contamination incurs into the contact sliding portion 1003. Consequently, stick-slip can be detected by monitoring the state of a measured dislocation by measuring the dislocation of the piston 1001 (See Japanese Patent 3254624 (“JP '624”)).

Here a simple explanation will be given regarding the detection of stick-slip set forth in JP '624. In this detecting technique, the dislocation of the piston 1001 is detected, a first state quantity is calculated from the detected dislocation, a second state quantity is calculated from the detected dislocation, and a relationship between the first state quantity and the second state quantity obtained from the dislocation during proper operation is compared to the relationship between the calculated first state quantity and calculated second state quantity, to detect (evaluate) the stick-slip.

For example, the average of the absolute values of first-order difference values for the dislocation may be used as the first state quantity, and the root mean square of the first-order difference values of the dislocation may be used as the second state quantity. When the dislocations of the piston 1001 are detected discreetly and the i^{th} detected dislocation is defined as Xi, then the respective state quantities can be expressed using Equation (1) and Equation (2), below (wherein N is the number of dislocation data used for calculating the state quantities):

$$\begin{matrix}( First State Quantity ) = \frac{1}{N - 1} {\sum }_{i = 1}^{N - 1} \vert {X}_{i + 1} - {X}_{i} \vert & ( 1 ) \\ ( Second State Quantity ) = \sqrt{\frac{1}{N - 1} {\sum }_{i = 1}^{N - 1} {( {X}_{i + 1} - {X}_{i} )}^{2}} & ( 2 )\end{matrix}$$

The frequency distribution of the absolute values (|Xᵢ₊₁−Xᵢ|) of the first-order differences of the dislocation is as illustrated in FIG. 11A and FIG. 11B. FIG. 11A illustrates the state during proper operation, wherein the frequency of occurrence falls smoothly with increasing magnitude of the difference values. On the other hand, if stick-slip occurs, then a majority of the time will be a stationary state, and then slipping will occur occasionally. Because of this, the frequencies of the first-order difference values will have high frequencies clustered around zero, as illustrated in FIG. 11B, (corresponding to the stationary state), with relatively large values at low frequencies (corresponding to the slipping state). In the state wherein this type of stick-slip occurs, the ratio of the first state quantity (the average value of the absolute values of the first-order difference values) to the second state quantity (the root mean square of the first-order difference values) will be larger than during proper operation, making it possible to contact the stick-slip by monitoring the two state quantities.

However, in the technique set forth above, there is a problem in that in some cases there will be an incorrect evaluation that there is a state of stick-slip, due to the state of control of the moving portion (the piston).

In the technique set forth above, the detection is performed through the relationship of two state quantities calculated, from the dislocation of a moving portion, by calculating the motion that is subject to stick-slip detection, divided into a stationary state and a slipping state. This makes the determination using only the dislocation of the moving portion. Because of this, if the movement (dislocation) of the moving portion is similar to that of the stick-slip state, then the evaluation will be that there is stick-slip, even if the stick-slip is not actually occurring. This results in erroneous detection.

For example, in the control of a valve stem position using a positioner, if there is a large change in the valve stem dislocation control instruction value (a setting value or set point), then the behavior of the dislocation of the valve (the moving portion) at the time of the change of the control instruction value may be similar to that of the stick-slip state.

As illustrated in FIG. 12 (a), when control instruction values for dislocations wherein the time-series signals form a square wave by alternating two values over time, then the response of the valve stem dislocation for the regulator valve will, accordingly, be measured as the dislocation measurement values for the time-series signals as illustrated in FIG. 12 (b). The first-order difference values in this type of dislocation measurement value will be as illustrated in FIG. 12 (c). In this case, as illustrated in FIG. 12 (c), the majority of the first-order difference values will be clustered near to zero, where only the values immediately after the control instruction value has changed will be large.

This behavior is identical to the behavior of the stick-slip phenomenon wherein there is a stationary state the majority of the time, with occasional rapid movement in the slipping state.

The result is that, in the technique set forth above, there is incorrect detection of the occurrence of stick-slip when control is performed as illustrated in FIG. 12 (a). This incorrect detection tends to occur when the operating speed of the valve is high, and is particularly problematic in small valves.

The present invention is to solve the problem such as set forth above, and the object thereof is to enable the evaluation of the stick-slip state more correctly, in accordance with the state of control.

### SUMMARY OF THE INVENTION

The stick-slip detecting device according to the present invention includes a diagnosing portion for evaluating a malfunction of the movable portion having dislocation detecting means for detecting a dislocation of a movable portion having a contact sliding portion; first calculating means for calculating a first state quantity from the dislocation; second calculating means for calculating a second state quantity from the dislocation; a characteristic storing portion for storing a relationship between the first state quantity and the second state quantity, obtained from the dislocation at a time of proper operation of the movable portion, calculated in advance; state quantity estimating means for calculating an estimated state quantity by using the relationship that is stored in the characteristic storing portion to estimate the second state quantity from the first state quantity that was calculated by the first calculating means; diagnostic calculating means for evaluating a malfunction in the movable portion by comparing the second state quantity, calculated by the second calculating means, to the estimated state quantity; and a diagnosing operation controlling portion for controlling the operation of the diagnosing portion based on a magnitude of change of a measurement value that is either the magnitude of the dislocation of the movable portion or a process change magnitude that changes in accordance with the dislocation of the movable portion.

The stick-slip detecting device according to the present invention has a diagnosing portion for evaluating a malfunction of the movable portion including dislocation detecting means for detecting a dislocation of a movable portion having a contact sliding portion; first calculating means for calculating a first state quantity from the dislocation; second calculating means for calculating a second state quantity from the dislocation; a characteristic storing portion for storing a relationship between the first state quantity and the second state quantity, obtained from the dislocation at a time of proper operation of the movable portion, calculated in advance; a diagnostic calculating portion for evaluating a malfunction in the movable portion by comparing the relationship between the first state quantity, calculated by the first state quantity calculating portion, and the second state quantity, calculated by the second state quantity calculating portion, to the relationship stored in the characteristic storing portion; and a diagnosing operation controlling portion for controlling the operation of the diagnosing portion based on a magnitude of change of a measurement value that is either the magnitude of the dislocation of the movable portion or a process change magnitude that changes in accordance with the dislocation of the movable portion.

In the stick-slip detecting device, the diagnosing operation controlling portion may have dislocation magnitude calculating means for calculating a dislocation magnitude of a dislocation of a movable portion, detected by the dislocation detecting means, and operation controlling means for controlling an operation of a diagnosing portion by detecting the dislocation magnitude, calculated by the dislocation magnitude calculating means, exceeding a threshold value that has been set in advance. The diagnosing operation controlling portion may comprise dislocation magnitude calculating means for calculating a dislocation magnitude of a measurement value for a process change magnitude, and operation controlling means for stopping an operation of a diagnosing portion by detecting the dislocation magnitude, calculated by the dislocation magnitude calculating means, exceeding a threshold value that has been set in advance.

In the stick-slip detecting device set forth above, the diagnosing operation controlling portion may stop the operation of first calculating means and second calculating means to control the operation of the diagnosing portion. Additionally, the diagnosing operation controlling portion may stop the operation of the diagnostic calculating means to control the operation of the diagnosing portion. Additionally, the diagnosing operation controlling portion may start the operation control of the diagnosing portion based on a malfunction evaluation by the diagnostic calculating means and may discriminate the correctness/incorrectness of the malfunction evaluation by the diagnostic calculating means based on a change magnitude of a measured value that is either a dislocation magnitude of a movable portion or a process change magnitude that changes in accordance with the dislocation of the movable portion.

The stick-slip detecting device according to the present invention includes a diagnosing portion for evaluating a malfunction of the movable portion having dislocation detecting means for detecting a dislocation of a movable portion having a contact sliding portion; first calculating means for calculating a first state quantity from the dislocation; second calculating means for calculating a second state quantity from the dislocation; a characteristic storing portion for storing a relationship between the first state quantity and the second state quantity, obtained from the dislocation at a time of proper operation of the movable portion, calculated in advance; state quantity estimating means for calculating an estimated state quantity by using the relationship that is stored in the characteristic storing portion to estimate the second state quantity from the first state quantity that was calculated by the first calculating means; diagnostic calculating means for evaluating a malfunction in the movable portion by comparing the second state quantity, calculated by the second calculating means, to the estimated state quantity; and a diagnosing result discriminating portion for discriminating the correctness/incorrectness of the malfunction operation by the diagnostic calculating portion based on a magnitude of change of a measurement value that is either the magnitude of the dislocation of the movable portion or a process change magnitude that changes in accordance with the dislocation of the movable portion.

Furthermore, in the stick-slip detecting method as set forth in the present invention a dislocation of a movable portion having a contact sliding portion is detected; a first state quantity is calculated from the dislocation; a second state quantity is calculated from the dislocation; a relationship between the first state quantity and the second state quantity, obtained from the dislocation at a time of proper operation of the movable portion, calculated in advance, is used to calculate an estimated state quantity by estimating the second state quantity from the calculated first state quantity; a malfunction of the movable portion is evaluated by comparing the calculated second state quantity to the estimated state quantity; and the malfunction evaluating operation is controlled based on a magnitude of change of a measurement value that is either the magnitude of the dislocation of the movable portion or a process change magnitude that changes in accordance with the dislocation of the movable portion.

Furthermore, in the stick-slip detecting method as set forth in the present invention a dislocation of a movable portion having a contact sliding portion is detected; a first state quantity is calculated from the dislocation; a second state quantity is calculated from the dislocation; a malfunction of the movable portion is evaluated by comparing a relationship between the first state quantity and the second state quantity, obtained from the dislocation at a time of proper operation of the movable portion, calculated in advance, to a relationship between the calculated second state quantity to the estimated state quantity; and the malfunction evaluating operation is controlled based on a magnitude of change of a measurement value that is either the magnitude of the dislocation of the movable portion or a process change magnitude that changes in accordance with the dislocation of the movable portion.

In the stick-slip detecting method set forth above, a magnitude of change of a dislocation of a movable portion may be calculated, and the evaluating operation may be stopped by the calculated magnitude of change having exceeded a threshold value that has been set in advance. Additionally, a magnitude of change of a measurement value of a process change magnitude may be calculated, and the evaluating operation may be stopped by the calculated magnitude of change having exceeded a threshold value that has been set in advance. Additionally, the malfunction diagnosing operation may be stopped by discriminating the correctness/incorrectness of the malfunction evaluation based on a change magnitude of a measured value that is either a dislocation magnitude of a movable portion or a process change magnitude that changes in accordance with the dislocation of the movable portion.

Furthermore, in the stick-slip detecting method as set forth in the present invention a dislocation of a movable portion having a contact sliding portion is detected; a first state quantity is calculated from the dislocation; a second state quantity is calculated from the dislocation; a relationship between the first state quantity and the second state quantity, obtained from the dislocation at a time of proper operation of the movable portion, calculated in advance, is used to calculate an estimated state quantity by estimating the second state quantity from the calculated first state quantity; a malfunction of the movable portion is evaluated by comparing the calculated second state quantity to the estimated state quantity; and the correctness/incorrectness of a diagnosis of a malfunction is discriminated based on a magnitude of change of a measurement value that is either the magnitude of the dislocation of the movable portion or a process change magnitude that changes in accordance with the dislocation of the movable portion.

As explained above, the present invention makes it possible to control the malfunction evaluating operation based on a magnitude of change of a measurement value that is either the magnitude of the dislocation of the movable portion or a process change magnitude that changes in accordance with the dislocation of the movable portion, and thus has a superior effect of enabling the evaluation of a stick-slip state more accurately depending on the state of control.

### BRIEF DESCRIPTION OF THE DRAWINGS

FIG. 1 is a structural diagram illustrating the structure of a stick-slip detecting device as set forth in an example according to the present invention.

FIG. 2 is a structural diagram illustrating the structure of a stick-slip detecting device as set forth in an another example according to the present invention.

FIG. 3 is a structural diagram illustrating the structure of a stick-slip detecting device as set forth in a further example according to the present invention.

FIG. 4 is a structural diagram illustrating the structure of a stick-slip detecting device as set forth in a furthermore example according to the present invention.

FIG. 5 is a structural diagram illustrating the structure of a stick-slip detecting device as set forth in yet another example according to the present invention.

FIG. 6 is a structural diagram illustrating the structure of a stick-slip detecting device as set forth in an example according to the present invention.

FIG. 7 is a structural diagram illustrating the structure of a stick-slip detecting device as set forth in an another example according to the present invention.

FIG. 8 is a structural diagram illustrating the structure of a stick-slip detecting device as set forth in a further embodiment according to the present invention.

FIG. 9 is a structural diagram illustrating the structure of a stick-slip detecting device as set forth in yet another embodiment according to the present invention.

FIG. 10 is a structural diagram illustrating the structure of a device having a sliding part.

FIG. 11A is a histogram illustrating the distribution of the frequency of occurrences of first-order difference values in a dislocation signal obtained from a part that undergoes reciprocating sliding.

FIG. 11B is a histogram illustrating the distribution of the frequency of occurrences of first-order difference values in a dislocation signal obtained from a part that undergoes reciprocating sliding.

FIG. 12 is a timing chart illustrating the changes in the control instruction values, the dislocation measurement values, and the first-order difference values of the dislocation measurement values.

### DETAILED DESCRIPTION OF THE INVENTION

Forms for carrying out the present invention will be explained below in reference to the figures.

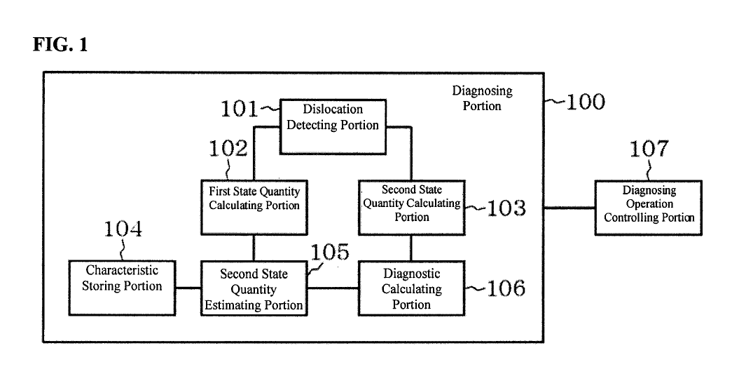

First FIG. 1 will be used to explain an example according to the present invention. FIG. 1 is a structural diagram illustrating the structure of a stick-slip detecting device as set forth in the present invention. This stick-slip detecting device is provided with a diagnosing portion 100 for diagnosing a malfunction in a movable portion that has a contact sliding portion such as, for example, a regulator valve. Additionally, the stick-slip detecting device is provided with a diagnosing operation controlling portion 107 for performing control such as stopping the operation of the diagnosing portion 100 based either a change magnitude of a movable portion, such as a valve, or on a change magnitude of a measured value of a process change magnitude that is changed by the dislocation of the movable portion.

Additionally, the diagnosing portion 100 is provided with a dislocation detecting portion 101, a first state quantity calculating portion (first calculating means) 102, a second state quantity calculating portion (second calculating means) 103, a characteristic storing portion 104, a second state quantity estimating portion 105, and a diagnostic calculating portion 106.

The dislocation detecting portion 101 detects (measures) the dislocation of a movable portion of a valve unit, or the like. The first state quantity calculating portion 102 calculates a first state quantity from the detected dislocation of the movable portion. The second state quantity calculating portion 103 calculates a second state quantity from the detected dislocation of the movable portion. The characteristic storing portion 104 stores the relationship between the first state quantity and the second state quantity obtained from the dislocations at the time of proper operation of the movable portion, calculated in advance. The second state quantity estimating portion 105 uses the relationship stored in the characteristic storing portion 104 to calculate an estimated state quantity by estimating the second state quantity from the first state quantity that has been calculated by the first state quantity calculating portion 102. The diagnostic calculating portion 106 evaluates a malfunction in the movable portion by comparing the estimated state quantity to the second state quantity calculated by the second state quantity calculating portion 103.

The diagnosing operation controlling portion 107 will be explained in more detail next. For example, a regulator valve is controlled automatically from the outside through a physician or, and controlled through a manual operation. Additionally, the control may be performed through an adjusting mechanism in the valve itself, such as in an automatic valve. The results of this control is a dislocation (change) of the valve stem. Additionally, there will be a change in a process change magnitude, such as the magnitude of flow of a fluid that passes through the regulator valve, in accordance with the magnitude of dislocation of the valve stem. In this way, the diagnosing operation controlling portion 107 controls the operation of the diagnosing portion 100 based on the magnitude of dislocation of the valve stem or on the magnitude of change of the measurement results (the measurement value) of a process change magnitude, such as a magnitude of flow.

For example, the diagnosing operation controlling portion 107 compares the magnitude of change of the measured dislocation of the valve stem to a reference value that has been set in advance, and if the magnitude of change per unit time in the measured dislocation of the valve stem exceeds the reference value, then the malfunction evaluating operation in the diagnosing portion 100 is stopped.

When control is performed such that the dislocation of the valve stem will change largely over time, then even if operating properly, the evaluation may be identical to the case wherein a stick-slip has occurred. In contrast, the diagnosing operation controlling portion 107, when the magnitude of change per unit time of the measured value for the valve stem dislocation that reflects a change in the control instruction value exceeds the reference value, stops the operation of the diagnosing portion 100, thus making it possible to prevent an incorrect stick-slip evaluation.

Furthermore, because the dislocation of the valve stem, which is a movable portion, is reflected also in a change of a process change magnitude, such as a magnitude of flow, incorrect detection can be controlled, in the same manner as set forth above, even in measurement values of process change magnitudes, such as magnitudes of flow. Preferably the process change magnitude that is used here is a physical magnitude that is controlled directly by the dislocation of the movable portion. For example, in the case of a regulator valve, it is a magnitude of flow of a fluid that passes through the valve, or a physical magnitude (such as a pressure or a temperature) that is controlled by operating the magnitude of flow. Moreover, even if not a physical magnitude that is controlled directly, enablement is also possible with a physical magnitude that is coordinated with the dislocation of the movable portion, with a strong correlation coefficient. On the other hand, a measurement value wherein no change is seen even when there is a change in the dislocation of the movable portion, that is, a measurement value with a weak correlation to the dislocation of the movable portion, cannot be used.

The reference value will be explained briefly here.

First an explanation will be given for a case of a diagnosis wherein a control instruction value can be applied explicitly from the outside. Control instruction values are applied in the shape of a square wave, so as to reciprocate between two values, A1 and A2, to a movable portion (which is subject to detection) that is in a normal state wherein there is no stick-slip state. The time interval for switching the control instruction value preferably is about the same as the interval for the changes in the instruction values with the highest frequencies occurring during the actual operations. The two state quantities are calculated from the dislocation measurement values wherein the results of the movable portion being operated by the control instruction values have been measured, and are applied to the method set forth in JP '624, to evaluate proper operation versus a malfunction. In this evaluation, if the evaluation is that of a malfunction, then the magnitude of change in the dislocation of the movable portion due to the control instruction value applied is a value that may cause an incorrect detection, and thus the difference between A1 and A2 is reduced slightly and the experiment is performed again.

Performing the operations using control instruction values obtained experimentally in this way makes it possible to determine how large the magnitude between A1 and A2 (the magnitude of change in the control instruction values) must be to cause an incorrect malfunction detection. Additionally, calculating, from the device specifications, or measuring experimentally, the magnitude of change of the magnitude of dislocation of the movable portion when the control instruction value has moved by this magnitude of change, make it possible to know how large the degree of the scope of change in the dislocation of the movable portion must be to define a malfunction as an incorrect detection. Consequently, the lower limit for the magnitude of change of the magnitude of dislocation of the movable portion that will be evaluated as a malfunction can be calculated, and this lower limit value may be used as the reference value. When a magnitude of change of a dislocation of the movable portion that exceeds a reference value determined in this way is detected, then, through that which is described above, the diagnosing portion 100 can be considered to incorrectly evaluate the occurrence of stick-slip. In other words, it is possible to prevent an incorrect detection through the diagnosing operation controlling portion 107 stopping the operation of the diagnosing portion 100 when a change of a magnitude of dislocation that exceeds the aforementioned reference value is detected. The operation of the diagnosing portion 100 should be stopped while the magnitude of change of the dislocation is in excess of the reference value, or at a set time after the magnitude of change of the dislocation has exceeded the reference value.

Additionally, calculating a magnitude of change of the measurement value of the process change magnitude wherein the magnitude of change of the dislocation of the movable portion is the magnitude of change of the lower limit value, and using this as the reference value makes it possible to control the incorrect detection by the diagnosing operation controlling portion 107 stopping the operation of the evaluating portion 100, in the same manner as described above, when the magnitude of change of the measurement value of the process change measurement in excess of the reference value is detected.

On the other hand, in the case of a device that operates without the application of a control instruction value from the outside, such as an automatic valve, the determination of a reference value through a control instruction value, such as described above, is not possible because the control instruction value explicitly does not exist. In such a case, the reference value can be determined by storing a dislocation change magnitude when the equipment being diagnosed is thought to be operating properly, such as immediately following setup. For example, two state quantities, and the maximum value for the dislocation change quantity in the interval over which the state quantities are calculated can be calculated. At this time, if there is an evaluation, by the diagnosing portion, that there has been a stick-slip, then the calculated dislocation change magnitude is a value at which an incorrect detection can occur. The smallest dislocation change magnitude among the maximum values of the magnitudes of change of the dislocations measured wherein there has been an evaluation that a stick-slip that can be evaluated as an incorrect detection has occurred can be used as the reference value.

Note that if there is a mathematical model of that which is to be detected when operating properly, then instead of the method for determining the reference value described above, a computer simulation may be used to determine a specific reference value in the same way. Note that in this case is necessary to calculate the state quantities after applying the tolerances and the same amounts of external noise for the dislocation detecting portion 101.

However, in determining the reference value, it is important to not stop at the diagnosing portion incorrectly when a stick-slip has actually occurred. When the movable portion has entered a sliding state after the occurrence of a stick-slip, the value of the magnitude of change of the dislocation that is measured exhibits the maximum value in comparison to when operating properly. This value is normally smaller than the value for the magnitude of change that can occur when there is an incorrect detection, and thus there is little likelihood that this will be a problem. Using the case of a regulator valve as an example, the magnitude of change of the dislocation of the movable portion due to a stick-slip (the difference between the position after sliding and the position before sliding) is between about 0.5% and 2%, with a maximum of about 5%, of the maximum magnitude of dislocation of the regulator valve (the distance of dislocation between when the valve is fully open and when the valve is fully closed. In contrast, the magnitude of change when an incorrect detection has occurred is between about 20% and 100% of the maximum magnitude of dislocation, and is about 10% even when relatively small.

In such circumstances, if the reference value is too small, then, in fact, there will be the risk of stopping the evaluating portion until a stick-slip actually occurs. Consequently, when determining the reference value relative to the magnitude of change, preferably the reference value is confirmed to not be a value that is so small that it can be assumed even when a stick-slip occurs.

Additionally, there would be the danger of stopping the evaluation operation incorrectly due to the effect of noise if the reference value described above were less than about the same as the magnitude of the noise when measuring the dislocation of the movable portion or the process change magnitude. Consequently, when determining the reference value relative to the magnitude of change, preferably the reference value is confirmed to be adequately larger than the magnitude of change that can occur normally due to the measurement noises.

Note that the diagnosing operation controlling portion 107 may stop the evaluating operation in the diagnosing portion 100 by stopping the calculating operation, for example, in the first state quantity calculating portion 102 and the second state quantity calculating portion 103. Additionally, the evaluating operation in the diagnosing portion 100 may be stopped by, for example, stopping the operation of the diagnostic calculating portion 106. The diagnosing operation controlling portion 107, after stopping the operation of the diagnosing portion 100 as described above, may restart (or start) the operation of the diagnosing portion 100 after a time that has been set has elapsed, or after the dislocation of the valve stem (the movable portion) or the scope of change per unit time of the process change magnitude has fallen to less than a specific value.

Here there are various types of time delays until the comparison of the magnitude of change of the dislocation of the valve stem or of the process change magnitude and the reference value. As causes for these delays there are delays caused by time for calculating the magnitude of change, delays until the change in the dislocation of the movable portion has an effect on the process change magnitude (such as the transmission delay in the flow of the fluid from the regulator valve to the flow meter), and delays due to the device that measures the process change magnitude. Because of this, at the point in time that the magnitude of change is detected as exceeding the reference value, the state may already be one that is ill-suited to the diagnosis, and there may already be an incorrect detection in the diagnosing portion 100. In such a case, the operation of the diagnosing portion 100 may be delayed by, for example, the diagnosis results by the diagnosing portion 100 being outputted after a delay in accordance with the aforementioned time delay. For example, the first state quantity calculating portion 102 and the second state quantity calculating portion 103 may delay the calculations of the state quantities. Additionally, the dislocation detecting portion 101 may be provided with a temporary storing portion that stores the detection result temporarily, to output the detection result after a delay in accordance with the aforementioned time delay.

Additionally, when the diagnostic calculating portion 106 evaluates that there is a malfunction in the movable portion, the output of the malfunction evaluation from the diagnosing portion 100 may be stopped if the diagnosing operation controlling portion 107 has detected that the magnitude of change of a measurement value that has already been measured exceeds a reference value. In particular, if time is required before the malfunction evaluation by the diagnostic calculating portion 106, then the state of control of the movable portion at the time of the malfunction evaluation may be reflected in the measurement value for the process change magnitude that is measured when the diagnostic calculating portion 106 evaluation that there is a malfunction in the movable portion. In such a case, when the diagnostic calculating portion 106 has evaluated that there is a malfunction in the movable portion, the output of the malfunction evaluation from the diagnosing portion 100 may be stopped if the diagnosing operation controlling portion 107 has detected that the magnitude of change of a measurement of the measured process change magnitude exceeds a reference value.

As described above, in the present example, there is the distinctive feature of detecting the dislocation of a movable portion that has a contact sliding portion, calculating a first state quantity from the dislocation, then calculating a second state quantity from the calculated dislocation, followed by using the first state quantity and the second state quantity obtained from the dislocations wherein the movable portion is operating properly, calculated in advance, to calculate an estimated state quantity by calculating the second state quantity from the calculated first state quantity, and then evaluating a malfunction in the movable portion by comparing the calculated second state quantity to the estimated state quantity, and, additionally, stopping the malfunction evaluating operation based on a magnitude of change of a measurement value that is either the magnitude of the dislocation of the movable portion or a process change magnitude.

Given the present example, the diagnosing operation controlling portion 107 controls the operation of the diagnosing portion 100 based on a magnitude of change of a measurement value that is either the magnitude of the dislocation of the movable portion or a process change magnitude, thus making it possible to prevent an incorrect detection of the stick-slip, making it possible to evaluate the stick-slip status more accurately in accordance with the state of control.

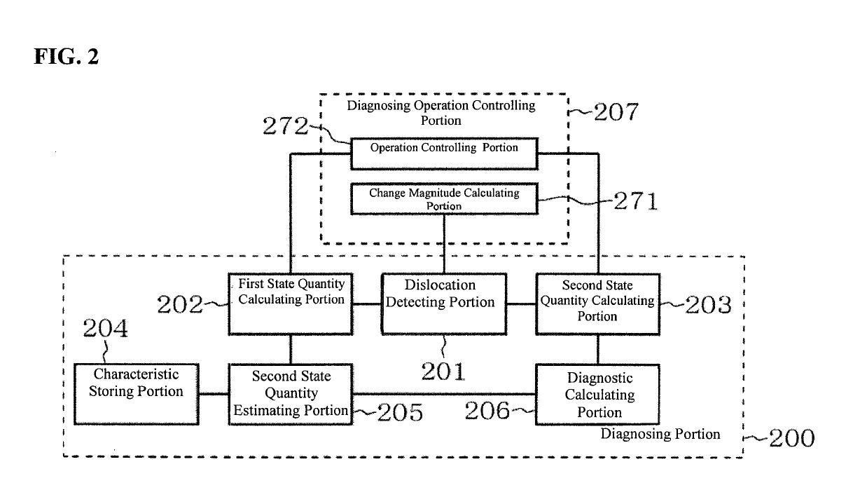

FIG. 2 will be used to explain another example according to the present invention. FIG. 2 is a structural diagram illustrating the structure of a stick-slip detecting device as set forth in a second form of embodiment according to the present invention. This stick-slip detecting device is provided with a diagnosing portion 200 for evaluating a malfunction in a movable portion that has a contact sliding portion, and a diagnosing operation controlling portion 207 for performing control such as stopping the operation of the diagnosing portion 200 based on magnitude of change of a measurement value of a magnitude of dislocation of a movable portion.

The diagnosing portion 200 is provided with a dislocation detecting portion 201, a first state quantity calculating portion 202 (first calculating means), a second state quantity calculating portion 203 (second calculating means), a characteristic storing portion 204, a second state quantity estimating portion 205, and a diagnostic calculating portion 206. Additionally, the diagnosing operation controlling portion 207 is provided with a change magnitude calculating portion 271 and an operation controlling portion 272.

The dislocation detecting portion 201 detects (measures) the dislocation of a movable portion of a valve unit, or the like, and outputs a dislocation signal that is a digital signal. The dislocation detecting portion 201 outputs the detected dislocation signal, after a set delay time, to the first state quantity calculating portion 202 and the second state quantity calculating portion 203. On the other hand, the dislocation detecting portion 201 outputs the detected dislocation signal to the change magnitude calculating portion 271 immediately.

The first state quantity calculating portion 202 calculates a mean square of first-order difference signals as a first state quantity from dislocation signals outputted from the dislocation detecting portion 201 as the measured values that indicate the dislocations detected for the movable portion. Additionally, the second state quantity calculating portion 203 calculates the mean square of second-order difference values as the second state quantity from the dislocation signals outputted from the dislocation detecting portion 201. The mean square of the first-order difference values and the mean square of the second-order differences value may be calculated using Equation (3) and Equation (4), below.

$$\begin{matrix}\overline{{( δ {x}_{τ} )}^{2}} = \frac{1}{N + 1} {\sum }_{i = 0}^{N} {( δ {x}_{τ - i Δ t} )}^{2} & ( 3 ) \\ \overline{{( {δ}^{2} {x}_{τ} )}^{2}} = \frac{1}{N + 1} {\sum }_{i = 0}^{N} {( {δ }^{2} {x}_{τ - i Δ t} )}^{2} & ( 4 )\end{matrix}$$

Note that δx is the difference in x over the time period Δt, and is calculated through Equation (5), below. Furthermore, δ²x is the difference in δx over the time period Δt, and is calculated similarly.

δxₜ=x_{t+Δt}−xₜ (5)

The characteristic storing portion 204 stores the relationship between the first state quantity and the second state quantity obtained from the dislocations at the time of proper operation of the movable portion, calculated in advance. For example, the characteristic storing portion 204 stores, as the relationship (characteristic formula) between the mean square of the first-order difference values and the mean square of the second-order difference values of the dislocation signal when the sliding operation of the movable portion is in the properly operating state, a linear approximation characteristic formula using two constants A and B, as illustrated by Equation (6), for example, below:

(̅δ̅²̅x̅_̅{̅τ̅}̅)̅²̅= A̅(̅δ̅x̅_̅{̅τ̅}̅)̅²̅+B (6)

The second state quantity estimating portion 205 uses the relationship stored in the characteristic storing portion 204 to calculate an estimated state quantity by estimating the second state quantity (the mean square of the second-order difference values) from the first state quantity (the mean square of the first-order difference values) calculated by the first state quantity calculating portion 202. For example, the second state quantity estimating portion 205 substitutes into Equation (6) the mean square for the first-order difference values, calculated by the first state quantity calculating portion 202, to calculate an estimated state quantity corresponding to the second-order difference values.

The diagnostic calculating portion 206 evaluates a malfunction in the movable portion by comparing the estimated state quantity to the second state quantity calculated by the second state quantity calculating portion 203. For example, the diagnostic calculating portion 206 calculates the difference between the mean square of the second-order difference values calculated by the second state quantity calculating portion 203 and the estimated state quantity estimated by the second state quantity estimating portion 205, and if, for example, the calculated difference is greater than a specific value, then concludes that a stick-slip has occurred.

As described above, during the evaluation of the stick-slip (a malfunction in the movable portion) by the diagnosing portion 200, in the present example the diagnosing operation controlling portion 207 stops the evaluating operation of the diagnosing portion 202 by stopping the operation of the first state quantity calculating portion 203 and the second state quantity calculating portion 200 based on a magnitude of change of a magnitude of dislocation of a movable portion detected (measured) by the dislocation detecting portion 201.

In the diagnosing operation controlling portion 207, first the change magnitude calculating portion 271 calculates the magnitude of change from the magnitude of dislocation of the movable portion detected by the dislocation detecting portion 201 (the dislocation signal). Then the operation controlling portion 272 compares the reference value that has been set to the magnitude of change that has been calculated, and if the scope of change per unit time of the magnitude of change that has been calculated exceeds the reference value, stops the calculation operations in the first state quantity calculating portion 202 and the second state quantity calculating portion 203. The operations of the first state quantity calculating portion 202 and of the second state quantity calculating portion 203 are stopped by, for example, the operation controlling portion 272 outputting a stop signal.

Here, as described above, the dislocation detecting portion 201 outputs a dislocation signal, after a set delay time, to the first state quantity calculating portion 202 and the second state quantity calculating portion 203. Consequently, the operation controlling portion 272, after outputting the result of the comparison between the reference value and the calculated magnitude of change, is able to output a dislocation signal to the first state quantity calculating portion 202 and the second state quantity calculating portion 203. The result is that the diagnosing operation controlling portion 207 is able to stop the operation prior to the diagnosing portion 200 (the diagnostic calculating portion 206) performs the evaluation operation.

Doing so makes it possible to prevent an incorrect stick-slip detection that would be caused by the state of control of the movable portion, as described previously, by stopping the stick-slip evaluation in the diagnosing portion 200.

Note that the dislocation signal outputted from the dislocation detecting portion 201 is a digital signal, and while the mean square of the first-order difference values was calculated as the first state quantity and the mean square of the second-order difference values was calculated as the second state quantity, there is no limitation thereto. For example, the average absolute value of the first-order difference value may be calculated as the first state quantity and the root mean square of the first-order difference value may be calculated as the second state quantity, as in Equation (1). Moreover, if the dislocation value is an analog signal, then the mean square of the first-order derivative value may be calculated as the first state quantity, and the mean square of the second-order derivative value may be calculated as the second state quantity.

For example, first the first state quantity calculating portion 202 may calculate the mean square over a time interval T, as indicated by Equation (7), shown below, from the first-order derivative value of the dislocation value when the relative dislocation x is measured for two sliding objects (for example, a piston and a cylinder). Additionally, the second state quantity calculating portion 203 calculates the mean square, over the time interval T, from the second-order derivative value of the dislocation signal, as shown in Equation (8), below.

$$\overline{{( \dot{x} )}^{2}} = \frac{1}{T} {\int }_{τ - T}^{τ} {\dot{x}}_{t}^{2} d t \qquad ( 7 )$$

where \dot{x}ₜ is the first derivative at time t.

$$\overline{{( \ddot{x} )}^{2}} = \frac{1}{T} {\int }_{τ - T}^{τ} {\ddot{x}}_{t}^{2} d t \qquad ( 8 )$$

where \ddot{x}ₜ is the second derivative at time t.

On the other hand the characteristic storing portion 204 stores, as the relationship (characteristic formula) between the mean square of the first-order difference values and the mean square of the second-order difference values of the dislocation signal when the sliding operation is in the properly operating state, a linear approximation characteristic formula using two constants A and B, as illustrated by Equation (9), for example, below:

\overline{(\ddot{x})²}= \overline{A(\dot{x})²}=B (9)

In the second state quantity estimating portion 205, the characteristic equation indicated in Equation (9) is used to estimate the mean square of the second-order derivative values from the mean square of the first-order derivative values obtained from the measured values. Additionally, in the diagnostic calculating portion 206, the difference between the mean square of the second-order derivative values (the estimated state quantity) estimated (calculated) by the second state quantity estimating portion 205 and the mean square of the second-order derivative values calculated by the second state quantity calculating portion 203 is calculated. If this difference is greater than a specific value, then the diagnostic calculating portion 206 concludes that a stick-slip has occurred. Note that instead the mean square of the first-order derivative values may be estimated from the mean square of the second-order derivative values and this estimated mean square of the first-order derivative values may be compared to the actual mean square of the first-order derivative values obtained from the dislocations.

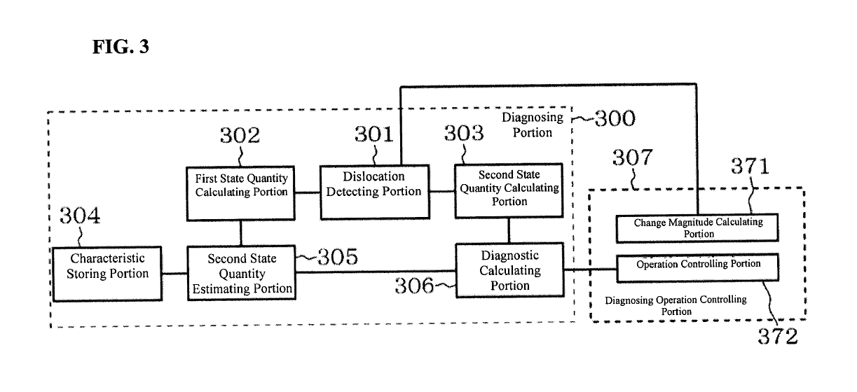

FIG. 3 will be used to explain a further example according to the present invention. FIG. 3 is a structural diagram illustrating the structure of a stick-slip detecting device as set forth in the present invention. This stick-slip detecting device is provided with a diagnosing portion 300 for evaluating a malfunction in a movable portion that has a contact sliding portion, and a diagnosing operation controlling portion 307 for performing control such as stopping the operation of the diagnosing portion 300 based on magnitude of change of a measurement value of a magnitude of dislocation of a movable portion.

The diagnosing portion 300 is provided with a dislocation detecting portion 301, a first state quantity calculating portion 302 (first calculating means), a second state quantity calculating portion 303 (second calculating means), a characteristic storing portion 304, a second state quantity estimating portion 305, and a diagnostic calculating portion 306. Additionally, the diagnosing operation controlling portion 307 is provided with a change magnitude calculating portion 371 and an operation controlling portion 372.

The dislocation detecting portion 301 detects (measures) the dislocation of a movable portion of a valve unit, or the like, and outputs a dislocation signal that is a digital signal. The dislocation detecting portion 301 outputs the detected dislocation signal, after a set delay time, to the first state quantity calculating portion 302 and the second state quantity calculating portion 303. On the other hand, the dislocation detecting portion 301 outputs the detected dislocation signal to the change magnitude calculating portion 371 immediately.

The first state quantity calculating portion 302 calculates a mean square of first-order difference signals as a first state quantity from dislocation signals outputted from the dislocation detecting portion 301 as the measured values that indicate the dislocations detected for the movable portion. Additionally, the second state quantity calculating portion 303 calculates the mean square of second-order difference values as the second state quantity from the dislocation signals outputted from the dislocation detecting portion 301.

The characteristic storing portion 304 stores the relationship between the first state quantity and the second state quantity obtained from the dislocations at the time of proper operation of the movable portion, calculated in advance. For example, the characteristic storing portion 304 stores, as the relationship (characteristic formula) between the mean square of the first-order difference values and the mean square of the second-order difference values of the dislocation signal when the sliding operation of the movable portion is in the properly operating state.

The second state quantity estimating portion 305 uses the relationship stored in the characteristic storing portion 304 to calculate an estimated state quantity by estimating the second state quantity (the mean square of the second-order difference values) from the first state quantity (the mean square of the first-order difference values) calculated by the first state quantity calculating portion 302.

The diagnostic calculating portion 306 evaluates a malfunction in the movable portion by comparing the estimated state quantity to the second state quantity calculated by the second state quantity calculating portion 303. For example, the diagnostic calculating portion 306 calculates the difference between the mean square of the second-order difference values calculated by the second state quantity calculating portion 303 and the estimated state quantity estimated by the second state quantity estimating portion 305, and if, for example, the calculated difference is greater than a specific value, then concludes that a stick-slip has occurred.

As described above, during the evaluation of the stick-slip (a malfunction in the movable portion) by the diagnosing portion 300, the diagnosing operation controlling portion 307 stops the evaluating operation of the diagnosing portion 300 by stopping the operation of the diagnostic calculating portion 306 based on a magnitude of change of a magnitude of dislocation of a movable portion detected (measured) by the dislocation detecting portion 301.

In the diagnosing operation controlling portion 307, first the change magnitude calculating portion 371 calculates the magnitude of change from the magnitude of dislocation of the movable portion detected by the dislocation detecting portion 301 (the dislocation signal). Then the operation controlling portion 372 compares the reference value that has been set to the magnitude of change that has been calculated, and if the scope of change per unit time of the magnitude of change that has been calculated exceeds the reference value, stops the operation of the diagnostic calculating portion 306. The operation of the diagnostic calculating portion 306 is stopped by, for example, the operation controlling portion 372 outputting a stop signal.

Here, as described above, the dislocation detecting portion 301 outputs a dislocation signal, after a set delay time, to the first state quantity calculating portion 302 and the second state quantity calculating portion 303. Consequently, the operation controlling portion 372, after outputting the result of the comparison between the reference value and the calculated magnitude of change, is able to output a dislocation signal to the first state quantity calculating portion 302 and the second state quantity calculating portion 303. The result is that the diagnosing operation controlling portion 307 is able to stop the operation prior to the diagnosing portion 300 (the diagnostic calculating portion 306) performs the evaluation operation.

Note that while in the present example the diagnosing operation controlling portion 307 controls the evaluation operation of the diagnosing portion 300 by causing a delay when the dislocation detecting portion 301 outputs the dislocation to the first state quantity calculating portion 302 and the second state quantity calculating portion 303, the location in which the delay is inserted is not limited to this location. The same effect can be achieved through delaying instead the output of each state quantity from each state quantity calculating portion to the diagnostic calculating portion 306, or by delaying the output of the diagnosis results by the diagnostic calculating portion 306.

Doing so makes it possible to prevent an incorrect stick-slip detection that would be caused by the state of control of the movable portion, as described previously, by stopping the stick-slip evaluation in the diagnosing portion 300.

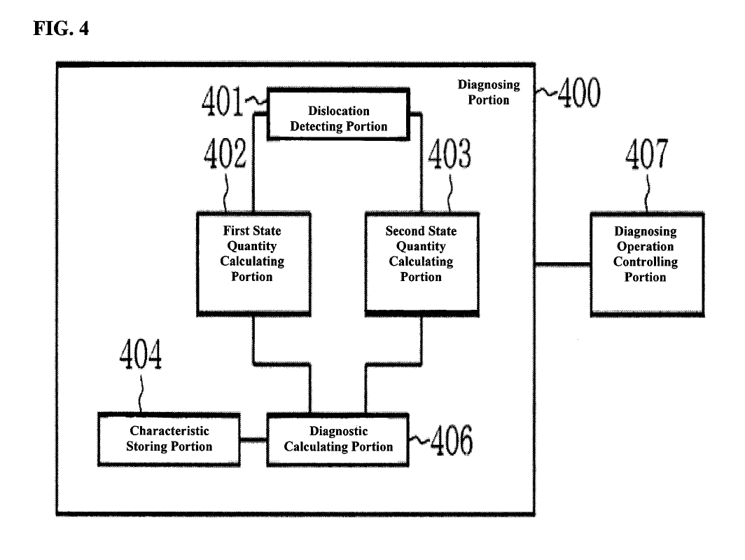

FIG. 4 will be used to explain yet another example according to the present invention. FIG. 4 is a structural diagram illustrating the structure of a stick-slip detecting device as set forth in the present invention. This stick-slip detecting device is provided with a diagnosing portion 400 for diagnosing a malfunction in a movable portion that has a contact sliding portion such as, for example, a regulator valve. Additionally, the stick-slip detecting device is provided with a diagnosing operation controlling portion 407 for performing control such as stopping the operation of the diagnosing portion 400 based either a change magnitude of a movable portion, such as a valve, or on a change magnitude of a measured value of a process change magnitude that is changed by the dislocation of the movable portion.

The diagnosing portion 400 is provided with a dislocation detecting portion 401, a first state quantity calculating portion 402 (first calculating means), a second state quantity calculating portion 403 (second calculating means), a characteristic storing portion 404, and a diagnostic calculating portion 406.

The dislocation detecting portion 401 detects (measures) the dislocation of a movable portion of a valve unit, or the like. The first state quantity calculating portion 402 calculates a first state quantity from the detected dislocations. The second state quantity calculating portion 403 calculates a second state quantity from the detected dislocations. The characteristic storing portion 404 stores the relationship between the first state quantity and the second state quantity obtained from the dislocations at the time of proper operation of the movable portion, calculated in advance. The diagnostic calculating portion 406 evaluates a malfunction in the movable portion by comparing the relationship between the first state quantity, calculated by the first state quantity calculating portion 402, and the second state quantity, calculated by the second state quantity calculating portion 403, to the relationship stored in the characteristic storing portion 404.

The diagnosing operation controlling portion 407 will be explained in more detail next. For example, the regulator valve may be controlled automatically from the outside, or may be controlled autonomously by an adjusting mechanism in the valve itself. The result of this control is a change in the dislocation of the valve stem (movable portion). Additionally, there will be a change in a process change magnitude, such as the magnitude of flow of a fluid that passes through the regulator valve, in accordance with the magnitude of dislocation of the valve stem. In this way, the diagnosing operation controlling portion 407 controls the operation of the diagnosing portion 400 based on the magnitude of dislocation of the valve stem or on the magnitude of change of the measurement results (the measurement value) of a process change magnitude.

For example, the diagnosing operation controlling portion 407 compares the magnitude of change of the measured dislocation of the valve stem to a reference value that has been set in advance, and if the magnitude of change in the measured dislocation of the valve stem exceeds the reference value, then the malfunction evaluating operation in the diagnosing portion 400 is stopped.

When control is performed such that the dislocation of the valve stem changes largely over time, then even if operating properly, the evaluation may be identical to the case wherein a stick-slip has occurred. In contrast, the diagnosing operation controlling portion 407, when the magnitude of change per unit time of the measured value for the valve stem dislocation that reflects a change in the control instruction value exceeds the reference value, stops the operation of the diagnosing portion 400, thus making it possible to prevent an incorrect stick-slip evaluation. These operations are identical to those described above. Furthermore, because the dislocation of the valve stem, which is a movable portion, is reflected also in a change of a process change magnitude, even when there is a measurement value of a process change magnitude, such as a magnitude of a flow, it is the same as described above.

Even in the present form, described above, as with the form described previously, the diagnosing operation controlling portion 407 controls the operation of the diagnosing portion 400 based on a magnitude of change of a measurement value that is either the magnitude of the dislocation of the movable portion or a process change magnitude that changes in accordance with the dislocation of the movable portion, and thus is able to evaluate the stick-slip state more accurately in accordance with the state of control, because of the ability to, for example, prevent an incorrect stick-slip detection. In addition, even when handling the time delay required before the comparison of the dislocation of the valve stem and the magnitude of change of the process change magnitude, still it will be the same as in the example set forth above.

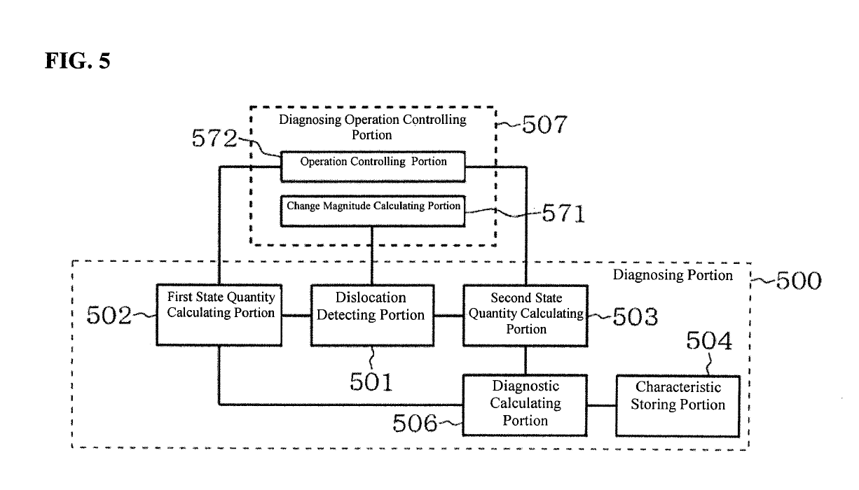

FIG. 5 will be used to explain an example according to the present invention. FIG. 5 is a structural diagram illustrating the structure of a stick-slip detecting device as set forth in the present invention. This stick-slip detecting device is provided with a diagnosing portion 500 for evaluating a malfunction in a movable portion that has a contact sliding portion, and a diagnosing operation controlling portion 507 for performing control such as stopping the operation of the diagnosing portion 500 based on magnitude of change of a measurement value of a magnitude of dislocation of a movable portion.

The diagnosing portion 500 is provided with a dislocation detecting portion 501, a first state quantity calculating portion 502 (first calculating means), a second state quantity calculating portion 503 (second calculating means), a characteristic storing portion 504, and a diagnostic calculating portion 506. Additionally, the diagnosing operation controlling portion 507 is provided with a change magnitude calculating portion 571 and an operation controlling portion 572.

The dislocation detecting portion 501 detects (measures) the dislocation of a movable portion of a valve unit, or the like, and outputs a dislocation signal that is a digital signal. The dislocation detecting portion 501 outputs the detected dislocation signal, after a set delay time, to the first state quantity calculating portion 502 and the second state quantity calculating portion 503. On the other hand, the dislocation detecting portion 501 outputs the detected dislocation signal to the change magnitude calculating portion 571 immediately.

The first state quantity calculating portion 502 calculates a mean square of first-order difference signals as a first state quantity from dislocation signals outputted from the dislocation detecting portion 501 as the measured values that indicate the dislocations detected for the movable portion. Additionally, the second state quantity calculating portion 503 calculates the mean square of second-order difference values as the second state quantity from the dislocation signals outputted from the dislocation detecting portion 501.

The characteristic storing portion 504 stores the relationship between the first state quantity and the second state quantity obtained from the dislocations at the time of proper operation of the movable portion, calculated in advance. The diagnostic calculating portion 506 calculates the relationship between the first state quantity calculated by the first state quantity calculating portion 502 and the second state quantity calculated by the second state quantity calculating portion 503, and compares this relationship to the relationship stored in the characteristic storing portion 504, to detect an occurrence of stick-slip.

As described above, during the evaluation of the stick-slip (a malfunction in the movable portion) by the diagnosing portion 500, in the present form of embodiment the diagnosing operation controlling portion 507 stops the evaluating operation of the diagnosing portion 500 by stopping the operation of the first state quantity calculating portion 502 and the second state quantity calculating portion 503 based on a magnitude of change of a magnitude of dislocation of a movable portion detected (measured) by the dislocation detecting portion 501.

In the diagnosing operation controlling portion 507, first the change magnitude calculating portion 571 calculates the magnitude of change from the magnitude of dislocation of the movable portion detected by the dislocation detecting portion 501 (the dislocation signal). Then the operation controlling portion 572 compares the reference value that has been set to the magnitude of change that has been calculated, and if the scope of change per unit time of the magnitude of change that has been calculated exceeds the reference value, stops the calculation operations in the first state quantity calculating portion 502 and the second state quantity calculating portion 503.

Here, as described above, the dislocation detecting portion 501 outputs a dislocation signal, after a set delay time, to the first state quantity calculating portion 502 and the second state quantity calculating portion 503. Consequently, the operation controlling portion 572, after outputting the result of the comparison between the reference value and the calculated magnitude of change, is able to output a dislocation signal to the first state quantity calculating portion 502 and the second state quantity calculating portion 503. The result is that the diagnosing operation controlling portion 507 is able to stop the operation prior to the diagnosing portion 500 (the diagnostic calculating portion 506) performs the evaluation operation.

Doing so makes it possible to prevent an incorrect stick-slip detection that would be caused by the state of control of the movable portion, as described previously, by stopping the stick-slip evaluation in the diagnosing portion 500.

Note that the dislocation signal outputted from the dislocation detecting portion 501 is a digital signal, and while the mean square of the first-order difference values was calculated as the first state quantity and the mean square of the second-order difference values was calculated as the second state quantity, there is no limitation thereto. The average absolute value of the first-order difference value may be calculated as the first state quantity and the root mean square of the first-order difference value may be calculated as the second state quantity, as in Equation (1). If the dislocation value is an analog signal, then the mean square of the first-order derivative value may be calculated as the first state quantity, and the mean square of the second-order derivative value may be calculated as the second state quantity.

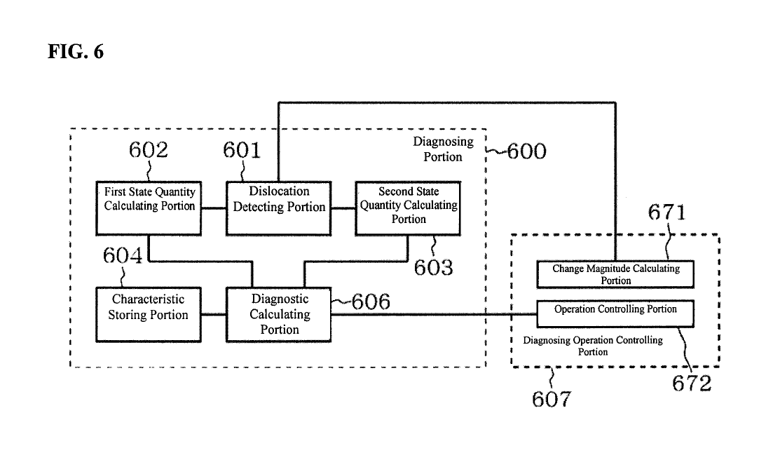

FIG. 6 will be used to explain another example according to the present invention. FIG. 6 is a structural diagram illustrating the structure of a stick-slip detecting device as set forth in the present invention. This stick-slip detecting device is provided with a diagnosing portion 600 for evaluating a malfunction in a movable portion that has a contact sliding portion, and a diagnosing operation controlling portion 607 for performing control such as stopping the operation of the diagnosing portion 600 based on magnitude of change of a measurement value of a magnitude of dislocation of a movable portion.

The diagnosing portion 600 is provided with a dislocation detecting portion 601, a first state quantity calculating portion 602 (first calculating means), a second state quantity calculating portion 603 (second calculating means), a characteristic storing portion 604, and a diagnostic calculating portion 606. Additionally, the diagnosing operation controlling portion 607 is provided with a change magnitude calculating portion 671 and an operation controlling portion 672.

The dislocation detecting portion 601 detects (measures) the dislocation of a movable portion of a valve unit, or the like, and outputs a dislocation signal that is a digital signal. The dislocation detecting portion 601 outputs the detected dislocation signal, after a set delay time, to the first state quantity calculating portion 602 and the second state quantity calculating portion 603. On the other hand, the dislocation detecting portion 601 outputs the detected dislocation signal to the change magnitude calculating portion 671 immediately.

The first state quantity calculating portion 602 calculates a mean square of first-order difference values as a first state quantity from dislocation signals outputted from the dislocation detecting portion 601 as the measured values that indicate the dislocations detected for the movable portion. Additionally, the second state quantity calculating portion 603 calculates the mean square of second-order difference values as the second state quantity from the dislocation signals outputted from the dislocation detecting portion 601.

The characteristic storing portion 604 stores the relationship between the first state quantity and the second state quantity obtained from the dislocations at the time of proper operation of the movable portion, calculated in advance. The diagnostic calculating portion 606 calculates the relationship between the first state quantity calculated by the first state quantity calculating portion 602 and the second state quantity calculated by the second state quantity calculating portion 603, and compares this relationship to the relationship stored in the characteristic storing portion 604, to detect an occurrence of stick-slip.

As described above, during the evaluation of the stick-slip (a malfunction in the movable portion) by the diagnosing portion 600, the diagnosing operation controlling portion 607 stops the evaluating operation of the diagnosing portion 600 by stopping the operation of the diagnostic calculating portion 606 based on a magnitude of change of a magnitude of dislocation of a movable portion detected by the dislocation detecting portion 601.

In the diagnosing operation controlling portion 607, first the change magnitude calculating portion 671 calculates the magnitude of change from the magnitude of dislocation of the movable portion detected by the dislocation detecting portion 601 (the dislocation signal). Then the operation controlling portion 672 compares the reference value that has been set to the magnitude of change that has been calculated, and if the scope of change per unit time of the magnitude of change that has been calculated exceeds the reference value, stops the operation of the diagnostic calculating portion 606.

Here, as described above, the dislocation detecting portion 601 outputs a dislocation signal, after a set delay time, to the first state quantity calculating portion 602 and the second state quantity calculating portion 603. Consequently, the operation controlling portion 672, after outputting the result of the comparison between the reference value and the calculated magnitude of change, is able to output a dislocation signal to the first state quantity calculating portion 602 and the second state quantity calculating portion 603. The result is that the diagnosing operation controlling portion 607 is able to stop the operation prior to the diagnosing portion 600 (the diagnostic calculating portion 606) performs the evaluation operation. Note that even in the present case, the location that is delayed is not limited to the output of the dislocation detecting portion 601. As with the example set forth above, the same effect can be achieved through delaying instead the output of each state quantity from each state quantity calculating portion to the diagnostic calculating portion 606, or by delaying the output of the diagnosis results by the diagnostic calculating portion 606.

Doing so makes it possible to prevent an incorrect stick-slip detection that would be caused by the state of control of the movable portion, as described previously, by stopping the stick-slip evaluation in the diagnosing portion 600.

FIG. 7 will be used to explain yet another example according to the present invention. FIG. 7 is a structural diagram illustrating the structure of a stick-slip detecting device as set forth in the present invention. This stick-slip detecting device is provided with a diagnosing portion 200 for evaluating a malfunction in a movable portion that has a contact sliding portion, and a diagnosing operation controlling portion 707 for performing control such as stopping the operation of the diagnosing portion 200 based on magnitude of change of a measurement value of a process change magnitude that is changed by a dislocation of a movable portion.

The diagnosing portion 200 is provided with a dislocation detecting portion 201, a first state quantity calculating portion 202 (first calculating means), a second state quantity calculating portion 203 (second calculating means), a characteristic storing portion 204, a second state quantity estimating portion 205, and a diagnostic calculating portion 206. These structures are identical to those described above.

In the present example, the diagnosing operation controlling portion 707 is provided with a process change magnitude measurement value receiving portion 771, a change magnitude calculating portion 772, and an operation controlling portion 773.

The process change magnitude measurement value receiving portion 771 receives a measurement result for the process change magnitude that is controlled by the regulator valve, for example, that is the subject of the diagnosing by the diagnosing portion 200. A case wherein the process change magnitude is a flow rate of a fluid is explained below. The change magnitude calculating portion 772 calculates the magnitude of the change, per unit time that is set in advance, based on the change in the flow rate measurement value received by the process change magnitude measurement value receiving portion 771. The operation controlling portion 773 stops the evaluating operation by the diagnosing portion 200, by stopping the operation of the first state quantity calculating portion 202 and the second state quantity calculating portion 203, if the magnitude of change calculated by the change magnitude calculating portion 772 exceeds a reference value that has been set.

For example, let us assume that control is performed a time t1 to change the opening of a regulator valve from 0% to 100%. The result of this control is that the opening of the regulator valve will change from a 0% state to a 100% state. The result is that the magnitude of flow of the fluid that is subject to control in the flow path downstream of the regulator valve will increase in accordance with the opening of the regulator valve; however, because there is normally a time delay until the effect of changing the opening of the regulator valve appears in the measurement value of the flow meter, the increase in the magnitude of flow commences after some delay. This time is defined as t2. When the opening of the regulator valve changes suddenly in this way, then, as described above, this may lead to an incorrect detection of the stick-slip in the diagnosing portion 200.

Here, first the flow rate measurement value that increases after time t2 is received by a process change magnitude measurement value receiving portion 771. In a change magnitude calculating portion 772, a first-order difference value is calculated for each unit time from the flow rate measurement values that are received. The flow rate measurement values change in a time series in accordance with the change in control, so the calculated first-order value will be a large value at the point in time of time t2. When this value exceeds the reference value, then the operation controlling portion 773, will output an operation stop signal continuously, over a specific time period from time t2, to the first state quantity calculating portion 202 and the second state quantity calculating portion 203.

On the other hand, the dislocation detecting portion 201, after a delay time that has been set, will output the detected dislocation signal to the first state quantity calculating portion 202 and the second state quantity calculating portion 203. Because of this, the sudden change in the dislocation caused by the operation stop signal will not appear in the dislocation signal inputted into the first state quantity calculating portion 202 and the second state quantity calculating portion 203 prior to the outputting of the operation stop signal.

When the first state quantity calculating portion 202 and the second state quantity calculating portion 203 receive this operation stop signal, then the calculating operations are stopped in the first state quantity calculating portion 202 and the second state quantity calculating portion 203. The calculating operations are stopped in the first state quantity calculating portion 202 and the second state quantity calculating portion 203 over the interval over which the operation stop signal is received.

The result is that when the dislocation signal that is detected at time t1 is delayed and outputted by the dislocation detecting portion 201, the calculating operations in the first state quantity calculating portion 202 and the second state quantity calculating portion 203 are stopped by the operation stop signal, stopping the calculations of the state quantities. In other words, the large values for the first-order difference values for the dislocation signal that would be diagnosed as a stick-slip are eliminated from the calculating operations. Consequently, for the specific period of time over which the operation stop signal is outputted from the operation controlling portion 773, the stick-slip evaluation in the diagnosing portion 200 is stopped, thereby making it possible to prevent incorrect stick-slip detection.

In addition, because this prevents incorrect detection based on the magnitude of change in the measurement value of the process change magnitude that is changed by the dislocation of the movable portion, this makes it possible to perform control of the diagnosing operations for a plurality of subjects of diagnoses, and for a set of diagnosing portions, using a single diagnosing operation controlling portion. For example, when the results of controlling a fluid by a plurality of regulator valves has an effect on a single flow meter, it is possible to control the stick-slip detection (the diagnosing operation) in a plurality of regulator valves based on the magnitude of change of the measurement value of the magnitude of flow (the process change magnitude) measured by the flow meter. Doing this makes it possible to reduce the cost of the diagnoses through enabling a reduction in the number of devices. Note that in the case wherein operations of a plurality of diagnosing portions are controlled by a single diagnosing operation controlling portion, preferably reference values are established for each subject of control by the diagnosing portions (for example, for each regulator valve); however, the reference value may instead be shared, using the reference value for that which is the smallest.

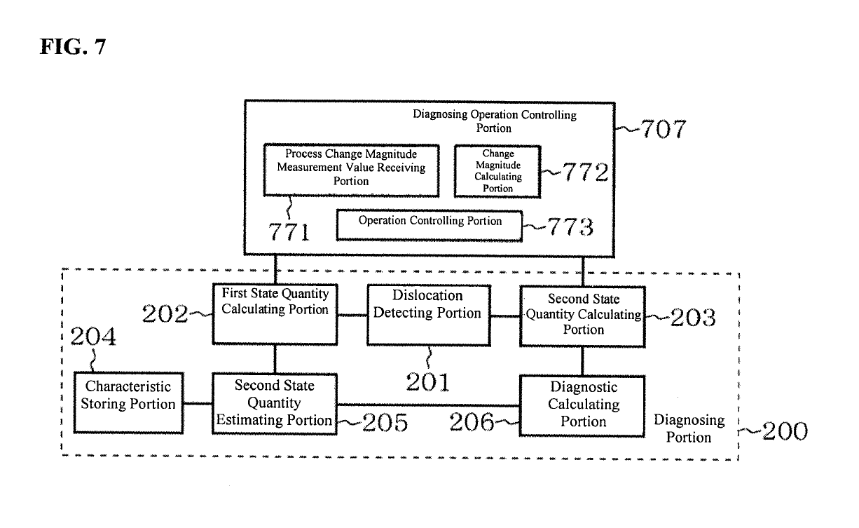

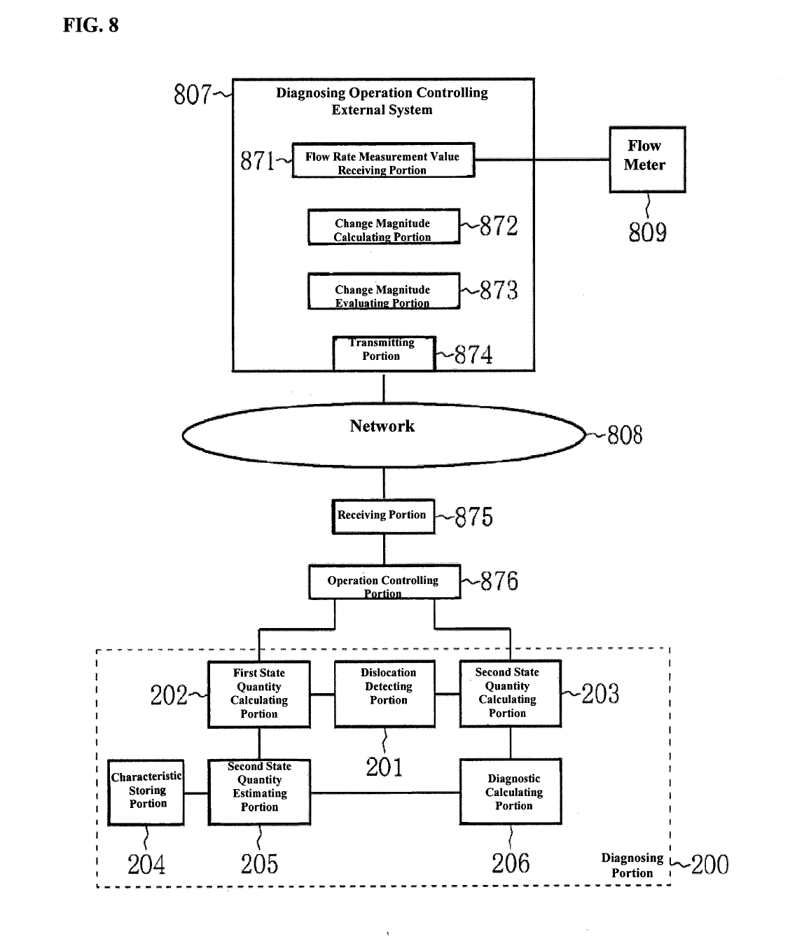

FIG. 8 will be used to explain an example according to the present invention. FIG. 8 is a structural diagram illustrating the structure of a stick-slip detecting device as set forth in the present invention. This stick-slip detecting device is provided with a diagnosing portion 200 for diagnosing a malfunction in a movable portion that has a contact sliding portion. The diagnosing portion 200 is identical to that in the examples described above.

Additionally, the stick-slip detecting device is provided with a diagnosing operation controlling external system 807 for transmitting evaluation signals for stopping the operation of the diagnosing portion 200 based on a magnitude of change of a measurement value of a process change magnitude (flow rate) that is changed by a dislocation of a movable portion, and an operation controlling portion 876 for stopping the operation of the diagnosing portion 200 based on the evaluation signal sent by the diagnosing operation controlling external system 807. The flow rate is measured by a flow meter 809 that is disposed downstream of a regulator valve, for example, that is provided with the movable portion, where the flow rate value measured by the flow meter 809 is communicated (sent) to the diagnosing operation controlling external system 807. The evaluation signal sent from the diagnosing operation controlling external system 807 is received by a receiving portion 875 that is connected through a network 808, and sent to the operation controlling portion 876.

In the present example, the diagnosing operation controlling external system 807 is provided with a flow rate measurement value receiving portion 871, a change magnitude calculating portion 872, a change magnitude evaluating portion 873, and a transmitting portion 874. Note that the diagnosing operation controlling external system 807 is preferably within the same system as an external controlling system that determines the control status of the movable portion, but might also be achieved through a separate system.

The flow rate measurement value receiving portion 871 receives a measurement result, from the flow meter 809, for the flow rate of the fluid that is controlled by the regulator valve, for example, that is the subject of the diagnosing by the diagnosing portion 200. When the diagnosing operation controlling external system 807 is incorporated into the equipment for the flow meter 809, the acquisition of the flow rate measurement value can be achieved through the transfer of data within the equipment. When embodied as a separate system, it is necessary to be able to receive the flow rate measurement values in real time through communication with the flow meter 809. The change magnitude calculating portion 872 calculates the magnitude of the change, per unit time that is set in advance, based on the change in the flow rate measurement value received. If the magnitude of change calculated by the change magnitude calculating portion 872 exceeds the reference value that has been set, then the change magnitude evaluating portion 873 outputs an operation stop signal. The transmitting portion 874 sends the operation stop signal that has been outputted from the change magnitude evaluating portion 873 to the receiving portion 875 through the network 808.

On the other hand, the dislocation detecting portion 201, after a delay time that has been set, will output the detected dislocation signal to the first state quantity calculating portion 202 and the second state quantity calculating portion 203. Because of this, the sudden change in the dislocation caused by the operation stop signal does not appear in the dislocation signal inputted into the first state quantity calculating portion 202 and the second state quantity calculating portion 203 prior to the outputting of the operation stop signal.

When this operation stop signal is received by the receiving portion 875, then the operation controlling portion 876 stops the calculating operations by the first state quantity calculating portion 202 and the second state quantity calculating portion 203. While this operation stop signal is received by the receiving portion 875, the operation controlling portion 876 stops the calculating operations by the first state quantity calculating portion 202 and the second state quantity calculating portion 203.

The result is that when the dislocation signal that has already been detected is delayed and outputted by the dislocation detecting portion 201, the calculating operations in the first state quantity calculating portion 202 and the second state quantity calculating portion 203 are stopped by the operation stop signal, stopping the calculations of the state quantities. In other words, the large values for the first-order difference values for the dislocation signal that would be diagnosed as a stick-slip are eliminated from the calculating operations. Consequently, for the specific period of time over which the operation stop signal is sent from the transmitting portion 874, the stick-slip evaluation in the diagnosing portion 200 is stopped, thereby making it possible to prevent incorrect stick-slip detection.

Given the above, the stick-slip evaluation is stopped in the diagnosing portion 200, in the same manner as in the seventh form of embodiment, described above, making it possible to prevent an incorrect stick-slip evaluation caused by the state of control of the movable portion, as described above.

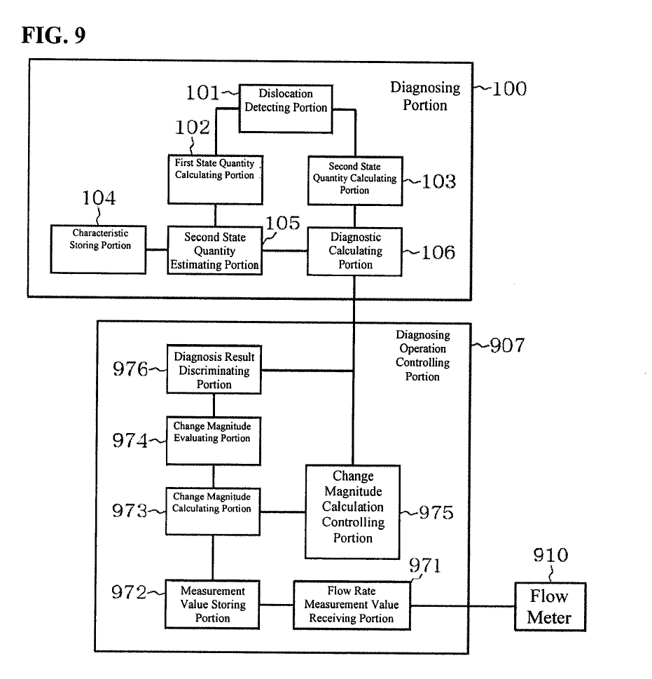

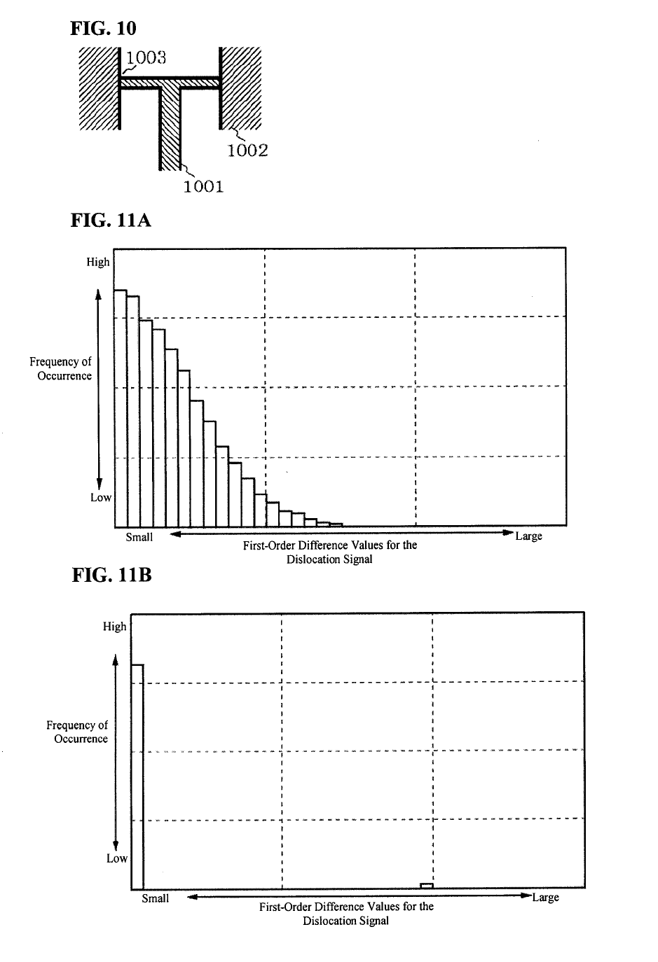

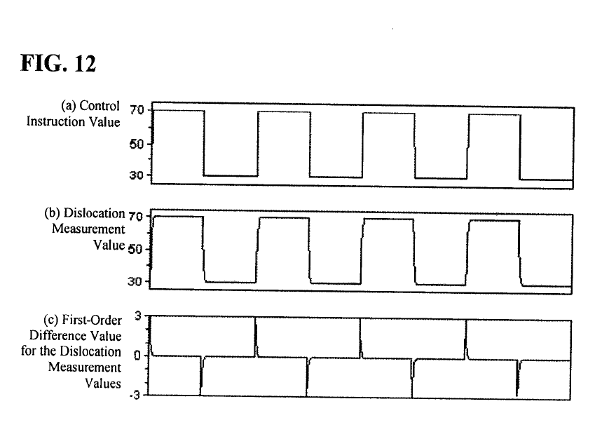

FIG. 9 will be used to explain another example according to the present invention. FIG. 9 is a structural diagram illustrating the structure of a stick-slip detecting device as set forth in a form of embodiment according to the present invention. This stick-slip detecting device is provided with a diagnosing portion 100 for diagnosing a malfunction in a movable portion that has a contact sliding portion such as, for example, a regulator valve.

Additionally, the stick-slip detecting device is provided with a diagnosing operation controlling portion 907 for performing correct/incorrect discrimination of the evaluations by the diagnosing portion 100, based on a magnitude of change of a measurement value of a flow rate that changes in accordance with a dislocation of a valve stem, which is a movable portion. The flow rate is measured by a flow meter 910 that is disposed downstream of a regulator valve, for example, that is provided with the movable portion, where the flow rate value measured by the flow meter 910 is communicated to the diagnosing operation controlling portion 907.

The diagnosing portion 100 is provided with a dislocation detecting portion 101, a first state quantity calculating portion (first calculating means) 102, a second state quantity calculating portion (second calculating means) 103, a characteristic storing portion 104, a second state quantity estimating portion 105, and a diagnostic calculating portion 106. The diagnosing portion 100 is identical to that described above.

The dislocation detecting portion 101 detects (measures) the dislocation of a movable portion of a valve unit, or the like. The first state quantity calculating portion 102 calculates a first state quantity from the detected dislocation of the movable portion. The second state quantity calculating portion 103 calculates a second state quantity from the detected dislocation of the movable portion. The characteristic storing portion 104 stores the relationship between the first state quantity and the second state quantity obtained from the dislocations at the time of proper operation of the movable portion, calculated in advance.

The second state quantity estimating portion 105 uses the relationship stored in the characteristic storing portion 104 to calculate an estimated state quantity by estimating the second state quantity from the first state quantity that has been calculated by the first state quantity calculating portion 102. The diagnostic calculating portion 106 evaluates a malfunction in the movable portion by comparing the estimated state quantity to the second state quantity calculated by the second state quantity calculating portion 103, and outputs that a malfunction is been detected (malfunction detecting signal).

The diagnosing operation controlling portion 907 will be explained next. The diagnosing operation controlling portion 907 is provided with a flow rate measurement value receiving portion 971, a measurement value storing portion 972, a change magnitude calculating portion 973, a change magnitude evaluating portion 974, and a diagnosis result discriminating portion 976.

The flow rate measurement value receiving portion 971 receives a measurement result, from the flow meter 910, for the flow rate of the fluid that is controlled by the regulator valve. The flow rate measurement value receiving portion 971 receives, from the flow meter 910, flow rate measurement values in a time series. The measurement value storing portion 972 stores, in a time series, the flow rate measurement values that are received. The change magnitude calculating portion 973 calculates the magnitude of the change, per unit time that is set in advance, through the change in the flow rate measurement values that are stored in the time series in the measurement value storing portion 972. Additionally, the change magnitude calculating portion 973 begins the aforementioned calculating operation when a start instruction signal is received from the change magnitude calculation controlling portion 975. If the magnitude of change calculated by the change magnitude calculating portion 973 exceeds the reference value that has been set, then the change magnitude evaluating portion 974 outputs an operation stop signal.

The change magnitude calculation controlling portion 975, upon receipt of a malfunction detection signal outputted from the diagnostic calculating portion 106, communicates the start instruction signal to the change magnitude calculating portion 973, to start the change magnitude calculating operation. Additionally, the diagnosis result discriminating portion 976 discriminates the correctness/incorrectness of a malfunction detection signal that has been received, outputted from the diagnostic calculating portion 106, depending on whether or not there is an operation stop signal that is outputted from the change magnitude evaluating portion 974, and provides notification that a malfunction (a stick-slip) has occurred in the movable portion. Upon receipt of an operation stop signal in addition to the malfunction signal, the diagnosis result discriminating portion 976 defines the received malfunction signal as being an incorrect evaluation, and does not provide notification that a malfunction has occurred.

In the example set forth above, there is a distinctive feature in that the diagnosing operation controlling portion 907 discriminates the correctness/incorrectness of a malfunction evaluation by the diagnosing portion 100 (the diagnostic calculating portion 106) without the performance of operational control of the various components of the diagnosing portion 100. Given this type, it is possible to eliminate a large-scale change of equipment in an environment wherein the diagnosing portion 100 has already been installed, because it is necessary only to add the diagnosing operation controlling portion 907 without changing the diagnosing portion 100.

Here the state of dislocation of the movable portion at the time of measurement of the dislocation measurement value (the dislocation detection result) by the dislocation detecting portion 101 that is the basis of the evaluation of the malfunction of the movable portion by the diagnostic calculating portion 106 has a time delay until the reflection of the flow rate measurement value measured by the flow meter 910. This is due to the transmission delay that is inherent in the flow of the fluid from the regulator valve to the flow meter, and due to the measurement delay in the flow meter itself. Furthermore, time is required also in calculating the malfunction evaluation result based on the detected dislocation. This is because the calculations of the state quantities upon which the malfunction evaluations are made require change data over a specific period of time, as illustrated in Equations (1) through (4) and Equations (7) through (8). Furthermore, in nearly all cases the delay time in the flow rate measurements and the time for calculating the evaluation results are not the same.

Because of this, it is necessary to set the range of time for the measurements that are subject to calculation, for the flow rate measurement values that are used in the change magnitude calculations by the change magnitude calculating portion 973 after the malfunction detection signal outputted from the diagnostic calculating portion 106 is received by the change magnitude calculation controlling portion 975, in consideration of the calculating time for the results of the evaluation by the diagnostic calculating portion 106, and in consideration of the delay time of the flow rate measurement.

Here the evaluation results by the diagnostic calculating portion 106 is based on the dislocation measured by the dislocation detecting portion 101 between time t1 and t2. Furthermore, the time (delay time) inherent in the state of dislocation of the movable portion being reflected to the flow rate measurement value is defined as Tf. In this case, the flow rate measurement values from time t1+Tf to time t2+Tf may be used in the change magnitude calculation by the change magnitude calculating portion 973.

If, for example, the calculation time for the evaluation result is longer when compared with the delay time of the flow rate measurement, then the point at which the change magnitude calculating portion 973 receives the start instruction signal from the change magnitude calculation controlling portion 975 would be after the time t1+Tf has already elapsed. Consequently, the calculation of the magnitude of change requires the flow rate calculation values received by the flow rate measurement value receiving portion 971 between time t1+Tf until present, stored in the measurement value storing portion 972.

If, for example, the flow rate measurement delay time is longer when compared with the evaluation result calculating time, then the point at which the change magnitude calculating portion 973 receives the start instruction signal from the change magnitude calculation controlling portion 975 would be before the time t1+Tf is achieved. Consequently, the calculation of the magnitude of change should be performed using the flow rate measurement values received by the flow rate measurement value receiving portion 971 after waiting until time t1+Tf. In this case, there is no need for the measurement value storing portion 972.

In either case, the measurement time for the dislocation of the movable portion to be used in the calculation of the evaluation results can be understood from the specification of the diagnosing portion, and the delay time in the flow rate measurement, and the like, are times that can be measured. This makes it possible to set the range of time described above.

Note that the present invention is not limited to an example set forth above, but rather many alternate forms, including combinations of the various examples, are possible by individuals skilled in the art in the present field, within the technical concept of the present invention.

For example, while in the example set forth above, the diagnosing operation controlling portion performed the correct/incorrect discrimination for the malfunction evaluation upon receipt of a malfunction signal from the diagnostic calculating portion, there is no limitation thereto. For example, the change magnitudes can be calculated constantly, and a signal indicating that the state is ill-suited to malfunction evaluation may be outputted continuously while the calculated change magnitude is in excess of a reference value that is set in advance. It is possible to discern that the malfunction evaluation is an incorrect evaluation if there is a malfunction evaluation by the diagnostic calculating portion while the signal is being outputted.

1. A stick-slip detecting device comprising:
dislocation detector detecting a dislocation of a movable portion having a contact sliding portion;
first calculator calculating a first state quantity from the dislocation;
second calculator calculating a second state quantity from the dislocation;
a characteristic storing portion storing a relationship between the first state quantity and the second state quantity, obtained from the dislocation at a time of proper operation of the movable portion, calculated in advance;
state quantity estimator calculating an estimated state quantity by using the relationship that is stored in the characteristic storing portion to estimate the second state quantity from the first state quantity that was calculated by the first calculator; and
diagnostic calculator evaluating a malfunction in the movable portion by comparing the second state quantity, calculated by the second calculator, to the estimated state quantity; and
a diagnosing operation controlling, portion controlling the operation of the diagnosing portion based on a magnitude of change of a measurement value that is either the magnitude of the dislocation of the movable portion or a process change magnitude that changes in accordance with the dislocation of the movable portion.

2. A stick-slip detecting device comprising:
dislocation detector detecting a dislocation of a movable portion having a contact sliding portion;
first calculator calculating a first state quantity from the dislocation;
second calculator calculating a second state quantity from the dislocation;
a characteristic storing portion storing a relationship between the first state quantity and the second state quantity, obtained from the dislocation at a time of proper operation of the movable portion, calculated in advance;
an evaluating portion performing a malfunction evaluation of the movable portion, comprising a diagnostic calculating portion for evaluating a malfunction in the movable portion by comparing the relationship between the first state quantity, calculated by the first state quantity calculating portion, and the second state quantity, calculated by the second state quantity calculating portion, to the relationship stored in the characteristic storing portion; and
a diagnosing operation controlling portion controlling the operation of the diagnosing portion based on a magnitude of change of a measurement value that is either the magnitude of the dislocation of the movable portion or a process change magnitude that changes in accordance with the dislocation of the movable portion.

3. The stick-slip detecting device as set forth in claim 1, wherein:
the diagnostic operation controlling portion comprises:
change magnitude calculator calculating a magnitude of change of a dislocation of the movable portion, detected by the dislocation detector; and
operation controller detecting that the change magnitude calculated by the change magnitude calculator exceeds a threshold value that is set in advance, and controlling the operation of the diagnosing portion.

4. The stick-slip detecting device as set forth in claim 1, wherein:
the diagnostic operation controlling portion comprises:
change magnitude calculator calculating the magnitude of a change in the process change magnitude; and
operation controller detecting that the change magnitude calculated by the change magnitude calculator exceeds a threshold value that is set in advance, and stopping the operation of the diagnosing portion.

5. The stick-slip detecting device as set forth in claim 1, wherein:
the diagnosing operation controlling portion controls the operation of the diagnosing portion by stopping the operation of the first calculator and the second calculator.

6. The stick-slip detecting device as set forth in claim 1, wherein:
the diagnosing operation controlling portion controls the operation of the diagnosing portion by stopping the operation of the diagnostic calculator.

7. The stick-slip detecting device as set forth in claim 1, wherein:
the diagnosing operation controlling portion starts the operation control of the diagnosing portion based on a malfunction evaluation by the diagnostic calculator and discriminates the correctness/incorrectness of the malfunction evaluation by the diagnostic calculator based on a change magnitude of a measured value that is either a dislocation magnitude of a movable portion or a process change magnitude that changes in accordance with the dislocation of the movable portion.

8. A stick-slip detecting device comprising:
dislocation detector detecting a dislocation of a movable portion having a contact sliding portion;
first calculator calculating a first state quantity from the dislocation;
second calculator calculating a second state quantity from the dislocation;
a characteristic storing portion storing a relationship between the first state quantity and the second state quantity, obtained from the dislocation at a time of proper operation of the movable portion, calculated in advance;
state quantity estimator calculating an estimated state quantity by using the relationship that is stored in the characteristic storing portion to estimate the second state quantity from the first state quantity that was calculated by the first calculator; and
diagnostic calculator evaluating a malfunction in the movable portion by comparing the second state quantity, calculated by the second calculating means, to the estimated state quantity; and
a diagnosing operation controlling portion discriminating the correctness/incorrectness of a malfunction, by the diagnostic calculator, based on a magnitude of change of a measurement value that is either the magnitude of the dislocation of the movable portion or a process change magnitude that changes in accordance with the dislocation of the movable portion.

9. A stick-slip detecting method comprising the steps of:
a dislocation of a movable portion having a contact sliding portion detecting;
a first state quantity calculating from the dislocation;
a second state quantity calculating from the dislocation;
calculating an estimated state quantity by estimating the second state quantity from the calculated first state quantity based on a relationship between the first state quantity and the second state quantity, obtained from the dislocation at a time of proper operation of the movable portion, calculated in advance;
a malfunction of the movable portion evaluating by comparing the calculated second state quantity to the estimated state quantity; and
the malfunction evaluating operation controlling based on a magnitude of change of a measurement value that is either the magnitude of the dislocation of the movable portion or a process change magnitude that changes in accordance with the dislocation of the movable portion.

10. A stick-slip detecting method comprising the steps of:
a dislocation of a movable portion having a contact sliding portion detecting;
a first state quantity calculating from the dislocation;
a second state quantity calculating from the dislocation;
a relationship between the first state quantity and the second state quantity, obtained from the dislocation at a time of proper operation of the movable portion, calculated in advance, and a relationship between a calculated first state quantity and a calculated second state quantity comparing to evaluate the malfunction of the movable portion; and
the malfunction evaluating operation controlling based on a magnitude of change of a measurement value that is either the magnitude of the dislocation of the movable portion or a process change magnitude that changes in accordance with the dislocation of the movable portion.

11. The stick-slip detecting method as set forth in claim 9, further comprising the steps of:
a magnitude of a change the dislocation of the movable portion calculating; and
the evaluation operation stopping if the calculated magnitude of change is greater than a threshold value that is set in advance.

12. The stick-slip detecting method as set forth in claim 9, further comprising the steps of:
a magnitude of a change in a process change magnitude calculating; and
the evaluation operation stopping if the calculated magnitude of change is greater than a threshold value that is set in advance.

13. The stick-slip detecting method as set forth in claim 9, further comprising the steps of:
the malfunction diagnosing operation stopping by discriminating the correctness/incorrectness of the malfunction evaluation based on a change magnitude of a measured value that is either a dislocation magnitude of a movable portion or a process change magnitude that changes in accordance with the dislocation of the movable portion.

14. A stick-slip detecting method comprising the steps of:
a dislocation of a movable portion having a contact sliding portion detecting;
a first state quantity calculating from the dislocation;
a second state quantity calculating from the dislocation;
calculating an estimated state quantity by estimating the second state quantity from the calculated first state quantity based on a relationship between the first state quantity and the second state quantity, obtained from the dislocation at a time of proper operation of the movable portion, calculated in advance;
a malfunction of the movable portion evaluating by comparing the calculated second state quantity to the estimated state quantity; and
the correctness/incorrectness of the malfunction evaluation discriminating based on a magnitude of change of a measurement value that is either the magnitude of the dislocation of the movable portion or a process change magnitude that changes in accordance with the dislocation of the movable portion.

15. The stick-slip detecting device as set forth in claim 2, wherein:
the diagnostic operation controlling portion comprises:
change magnitude calculator calculating a magnitude of change of a dislocation of the movable portion, detected by the dislocation detector; and
operation controller detecting that the change magnitude calculated by the change magnitude calculator exceeds a threshold value that is set in advance, and controlling the operation of the diagnosing portion.

16. The stick-slip detecting device as set forth in claim 2, wherein:
the diagnostic operation controlling portion comprises:
change magnitude calculator calculating the magnitude of a change in the process change magnitude; and
operation controller detecting that the change magnitude calculated by the change magnitude calculator exceeds a threshold value that is set in advance, and stopping the operation of the diagnosing portion.

17. The stick-slip detecting device as set forth in claim 2, wherein:
the diagnosing operation controlling portion controls the operation of the diagnosing portion by stopping the operation of the first calculator and the second calculator.

18. The stick-slip detecting device as set forth in claim 2, wherein:
the diagnosing operation controlling portion controls the operation of the diagnosing portion by stopping the operation of the diagnostic calculator.

19. The stick-slip detecting device as set forth in claim 2, wherein:
the diagnosing operation controlling portion starts the operation control of the diagnosing portion based on a malfunction evaluation by the diagnostic calculator and discriminates the correctness/incorrectness of the malfunction evaluation by the diagnostic calculator based on a change magnitude of a measured value that is either a dislocation magnitude of a movable portion or a process change magnitude that changes in accordance with the dislocation of the movable portion.

20. The stick-slip detecting method as set forth in claim 10, further comprising the steps of:
a magnitude of a change the dislocation of the movable portion calculating; and
the evaluation operation stopping if the calculated magnitude of change is greater than a threshold value that is set in advance.

21. The stick-slip detecting method as set forth in claim 10, further comprising the steps of:
a magnitude of a change in a process change magnitude calculating; and
the evaluation operation stopping if the calculated magnitude of change is greater than a threshold value that is set in advance.

22. The stick-slip detecting method as set forth in claim 10, further comprising the steps of:
the malfunction diagnosing operation stopping by discriminating the correctness/incorrectness of the malfunction evaluation based on a change magnitude of a measured value that is either a dislocation magnitude of a movable portion or a process change magnitude that changes in accordance with the dislocation of the movable portion.
